(19) United States
(12) Patent Application Publication
(10) Pub. No.: US 2025/0042474 A1
(43) Pub. Date: Feb. 6, 2025

(54) FRAME FOR A VEHICLE AND VEHICLE

(71) Applicant: SC Autosports, LLC, Dallas, TX (US)

(72) Inventors: Xuepeng Luo, Jinhua (CN); Long Bao, Jinhua (CN); Sen Liu, Jinhua (CN)

(21) Appl. No.: 18/503,596

(22) Filed: Nov. 7, 2023

(30) Foreign Application Priority Data
Jul. 31, 2023 (CN) 202322041563.2

(51) Int. Cl. B62D 21/14

(52) U.S. Cl. CPC B62D 21/14

(57) ABSTRACT

A frame for vehicle and a vehicle, the frame including a frame assembly and a telescopic assembly, the frame assembly including a front frame and a rear frame; the telescopic assembly including a driving telescopic member for connecting to a driver, one end of the driving telescopic member connected to the front frame and the other end connected to the rear frame for extending or shrinking along a first direction under the drive of the driver so as to drive the front frame and the rear frame to extend or shrink along the first direction. The extending or shrinking of the frame is enabled by the above manner.

### FIELD OF THE INVENTION

The present application relates to the field of vehicle, in particularly, to a frame for vehicle and a vehicle.

### BACKGROUND OF THE INVENTION

A frame for a vehicle is a frame structure that spans the front and rear axles of a vehicle. Currently, the length of existing frames (e.g., golf cart frames, sightseeing cart frames, etc.) is fixed from the factory and cannot be adjusted, which occupies a large space when the frame is not in use or is being transported.

### SUMMARY OF THE INVENTION

The main technical problem solved by the present application is to provide a frame for vehicles and a vehicle capable of enabling extending or shrinking of the frame.

In order to solve the above technical problems, one technical solution adopted in the present application is that: a frame for vehicle is provided; the frame includes a frame assembly and a telescopic assembly; a frame assembly includes a front frame and a rear frame; a telescopic assembly includes a driving telescopic member for connecting to a driver, and one end of the driving telescopic member is connected to the front frame and the other end is connected to the rear frame for extending or shrinking in a first direction under the drive of the driver so as to drive the front frame and the rear frame to extend or shrink along the first direction.

The driving telescopic member includes a first tube body and a second tube body, the first tube body slidably connected to the second tube body, one end of the second tube body inserted into the first tube body from one end of the first tube body or one end of the first tube body inserted into the second tube body from one end of the second tube body, the other end of the first tube body connected to the front frame, and the other end of the second tube body connected to the rear frame for, in the case of being driven, the first tube body and the second tube body being slidden relative to each other along the first direction, so as to drive the front frame and the rear frame to slide relative to each other along the first direction.

The telescopic assembly further includes at least one auxiliary telescopic member, one end of the auxiliary telescopic member connected to the front frame and the other end connected to the rear frame for being driven to extend or shrink along the first direction when the driving telescopic member extends or shrinks along the first direction.

The auxiliary telescopic member includes a third tube body and a fourth tube body, the third tube body slidably connected to the fourth tube body, one end of the third tube body inserted into the fourth tube body from one end of the fourth tube body or one end of the fourth tube body inserted into the third tube body from one end of the third tube body, the other end of the third tube body connected to the front frame, and the other end of the fourth tube body connected to the rear frame for the third tube body and the fourth tube body being driven to extend or shrink along the first direction when the driving telescopic member extends or shrinks along the first direction; and/or, the telescopic assembly includes two auxiliary telescopic member provided on either side of the driving telescopic member.

The frame further includes a restraining assembly comprising a restraining pin and a restraining plate, the restraining pin movably connected to the rear frame, the restraining plate provided at one end of the third tube body near the restraining pin or provided at one end of the fourth tube body near the restraining pin, the restraining plate provided with a restraining hole for the restraining pin to penetrate, capable of restricting the driving telescopic member from extending or shrinking along the first direction when the restraining pin is inserted into the restraining hole on the restraining plate, so as to restrain the front frame and the rear frame from extending or shrinking along the first direction.

The restraining assembly further includes a restraining bracket comprising a first connecting plate and a second connecting plate provided in opposite and spaced apart positions, and a third connecting plate connecting one end of the first connecting plate to one end of the second connecting plate, the third connecting plate connected to the rear frame, and the restraining pin passed through the first connecting plate, the second connecting plate in sequence and movably connected to the restraining bracket; the restraining pin is convexly provided with a first restraining post, and one side of the third connecting plate facing the restraining pin is convexly provided with two spaced apart second restraining posts; wherein, after the restraining pin is detached from the restraining plate, the restraining pin is suspended from both the second restraining posts by means of the first restraining post, and the driving telescopic member is capable of extending or shrinking along the first direction, so as to drive the front frame and the rear frame to be capable of extending or shrinking along the first direction.

The outer peripheral edge of the second restraining post is provided with a groove, and the first restraining post is snapped into the groove when the first restraining pin is suspended from both the second restraining posts by means of the first restraining post.

The restraining pin convexly is provided with a first restraining post, and the restraining assembly further comprises a restraining bracket and a tactile switch; a restraining bracket is provided on the rear frame, the restraining pin is movably provided on the restraining bracket; a tactile switch is mounted on the restraining bracket and used for electrical connection to the driver; wherein, upon the restraining pin detached from the restraining plate, the first restraining post is crimped to the tactile switch, and the driving telescopic member is capable of extending or shrinking along the first direction, so as to drive the front frame and the rear frame to be capable of extending or shrinking along the first direction; upon the restraining pin inserted into the restraining hole on the restraining plate, the first restraining post is detached from the tactile switch.

The restraining bracket comprises a first connecting plate and a second connecting plate provided in opposite and spaced apart positions, and a third connecting plate connecting one end of the first connecting plate to one end of the second connecting plate, the third connecting plate connected to the rear frame, the restraining pin passed through the first connecting plate and the second connecting plate in sequence and movably connected to the restraining bracket; one side of the third connecting plate facing the restraining pin is convexly provided with two spaced apart second restraining posts, and the tactile switch is provided adjacent to one of the second restraining posts; wherein, after the restraining pin is detached from the restraining plate, the restraining pin is suspended from both the second restraining posts by means of the first restraining post and is crimped to the tactile switch.

In order to solve the above technical problems, another technical solution adopted in the present application is to provide a vehicle including the above frame for vehicle.

According to the above technical solutions, when the driving telescopic member is extended or shrunk along the first direction, it can drive the front frame and the rear frame connected thereto to extend or shrink along the first direction, so as to adjust the overall length of the frame, and achieve the adjustment of the length of the frame; on the other hand, the driving telescopic member is extended or shrunk along the first direction under the situation of being driven by a driver, i.e., the driving telescopic member, when driven by a driver, is able to automatically drive the front frame and the rear frame to extend or shrink along the first direction, and the adjustment of the extending or shrinking of the frame is more flexible and convenient. Therefore, by providing the driving telescopic member connected to the driver between the front frame and the rear frame, adjustment of the length of the frame is achieved, and the length of the frame can be adjusted more flexibly and conveniently. Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference similar features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is an exploded view of an embodiment of a frame for vehicle provided in the present application;

FIG. 2 is a schematic structural diagram of an embodiment of a frame for vehicle in an extending state provided in the present application;

FIG. 3 is a schematic structural diagram of an embodiment of a frame for vehicle in a shrinking state provided in the present application;

FIG. 4 is a schematic structural diagram of an embodiment of a vehicle in an extending state provided in the present application;

FIG. 5 is a schematic structural diagram of an embodiment of a vehicle in the process of extending or shrinking provided in the present application;

FIG. 6 is a schematic structural diagram of an embodiment of a vehicle in a shrinking state provided in the present application;

FIG. 7 is a schematic structural diagram of an embodiment of a restraining assembly provided in the present application;

FIG. 8 is a schematic partial structure diagram of an embodiment of a frame provided in the present application;

FIG. 9 is a schematic partial structure diagram the of another embodiment of the frame provided in the present application;

FIG. 10 is a cross-sectional view of an embodiment of a vehicle provided in the present application.

### DETAILED DESCRIPTION OF THE INVENTION

The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items or meant to be limited to only the listed item or items. It should be noted herein that any feature or component described in association with a specific embodiment may be used and implemented with any other embodiment unless clearly indicated otherwise.

Regarding applicability of 35 U.S.C. § 112. ¶ 6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification comprises references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems and methods are now described.

In order to make the purpose, technical solutions and advantages of the present application clearer, the technical solutions in the embodiments of the present application will be described clearly and completely in the following in association with the embodiments of the present application, and it is obvious that the embodiments described are a part of the embodiments of the present application and not all of the embodiments. On the basis of the embodiments in the present application, all other embodiments obtained by a person of ordinary skill in the art without making creative labor fall within the scope of protection of the present application. The following embodiments and features in the embodiments may be combined with each other in case of no conflict.

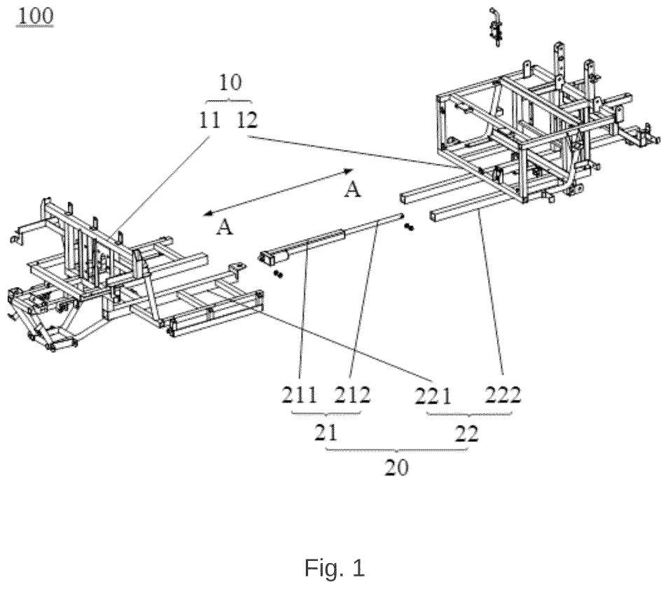

Referring to FIG. 1. FIG. 1 is an exploded view of an embodiment of a frame for vehicle provided in the present application. A frame for vehicle 100 is provided in the present application. The frame includes a frame assembly 10 and a telescopic assembly 20. A frame assembly 10 includes a front frame 11 and a rear frame 112. A telescopic assembly 20 includes a driving telescopic member 21 for connecting to a driver (not shown in the drawings), and one end of the driving telescopic member 21 is connected to the front frame 11 and the other end of the driving telescopic member 21 is connected to the rear frame 12 for extending or shrinking along a first direction under the drive of the driver so as to drive the front frame 11 and the rear frame 12 to extend or shrink along the first direction. On the one hand, when the driving telescopic member 21 is extended or shrunk along the first direction, it can drive the front frame 11 and the rear frame 12 connected thereto to expand or shrink along the first direction, so as to adjust the overall length of the frame 100, and achieve the adjustment of the length of the frame 100; on the other hand, the driving telescopic member 21 is extended or shrunk along the first direction under the situation of being driven by a driver, i.e., the driving telescopic member 21, when driven by a driver, is able to automatically drive the front frame 11 and the rear frame 12 to extend or shrink along the first direction, and the adjustment of the extending or shrinking of the frame 100 is more flexible and convenient. Therefore, by providing the driving telescopic member 21 connected to the driver between the front frame 11 and the rear frame 12, adjustment of the length of the frame 100 is achieved, and the length of the frame 100 can be adjusted more flexibly and conveniently.

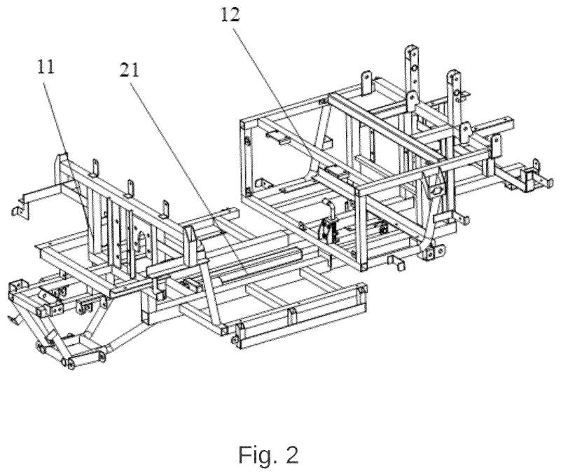

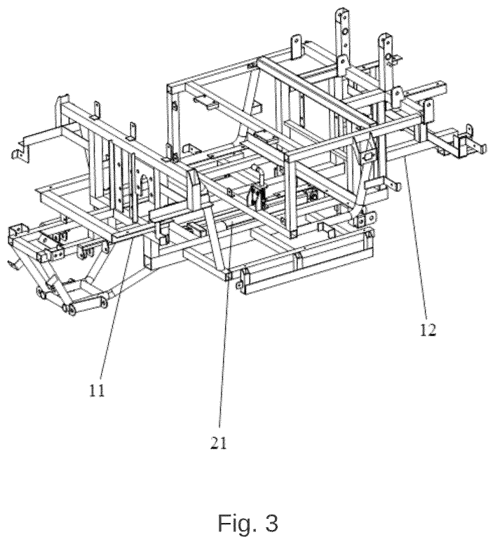

For example, as shown in FIG. 2, FIG. 2 is a schematic structural diagram of an embodiment of a frame for vehicle in an extending state provided in the present application. Assuming that the state of the driving telescopic member 21 is initially in the extending state, one end of the driving telescopic member 21 is connected to the front frame 11, and the other end of the driving telescopic member 21 is connected to the rear frame 12, so the spacing between the front frame 11 and the rear frame 12 is maximized and the frame 100 is in the fully extending state, thus the frame 100 is able to be used normally. As shown in FIG. 3, FIG. 3 is a schematic structural diagram of an embodiment of a frame for vehicle in a shrinking state provided in the present application. When the frame 100 needs to be shrunk, the driving telescopic member 21 can be driven by the driver, and the driving telescopic member 21 gradually shrinks along the first direction due to the driving of the driver, so that the front frame 11 and the rear frame 12 connected to the driving telescopic member 21 gradually shrink along the first direction, and the spacing between the front frame 11 and the rear frame 12 gradually decreases, so that the length of the frame 100 decreases and the frame 100 is in a shrinking (closing) state, so that the space occupied by the frame 100 can be reduced, and it is convenient to store and transport the frame 100 and reduce the packaging consumable materials.

Also for example, assuming that the state of the driving telescopic member 21 is initially a shrinking state, as shown in FIG. 3, the driving telescopic member 21 is in a shrinking state, and the spacing between the front frame 11 and the rear frame 12 connected by the driving telescopic member 21 is minimized, so the frame 100 is in a shrinking state, and the frame 100 cannot be used normally. As shown in FIG. 2, when the frame 100 is required to be used, the driving telescopic member 21 can be driven by the driver, the driving telescopic member 21 is gradually extended along the first direction by the driving of the driver, and the spacing between the front frame 11 and the rear frame 12 is gradually increased, so that the length of the frame 100 is increased, the frame 100 is restored to the extending state, and the frame 100 can be used normally.

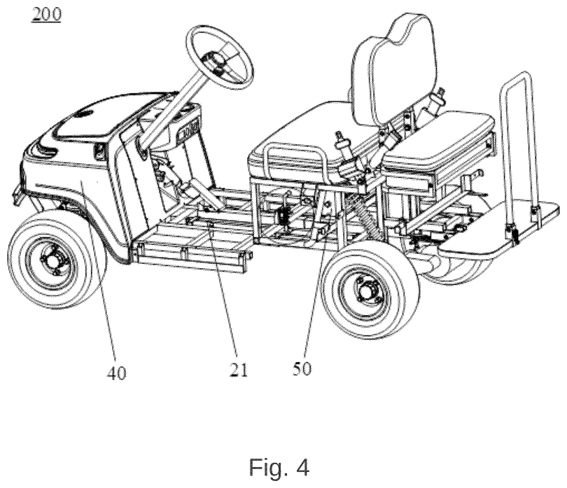

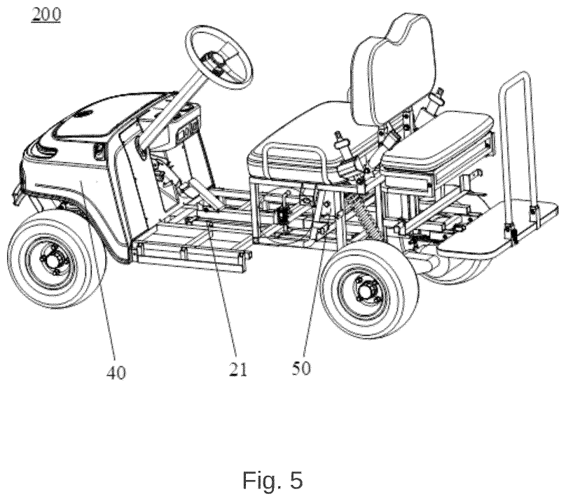

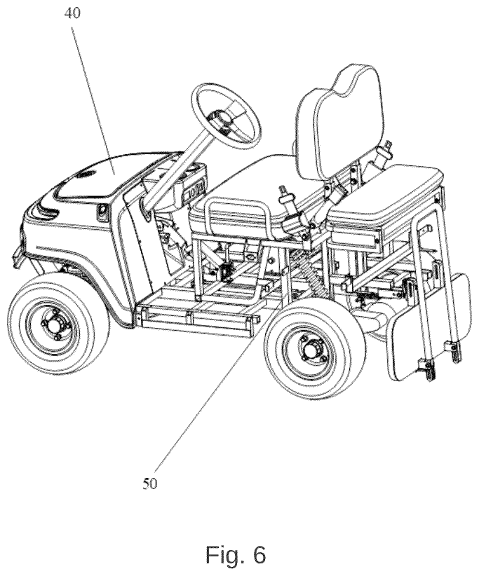

Further for example, referring to FIGS. 4-6, FIG. 4 is a schematic structural diagram of an embodiment of a vehicle in an extending state provided in the present application; FIG. 5 is a schematic structural diagram of an embodiment of a vehicle in the process of extending or shrinking provided in the present application; FIG. 6 is a schematic structural diagram of an embodiment of a vehicle in a shrinking state provided in the present application. As shown in FIG. 4, assuming that the state of the vehicle 200 initially is an extending state, one end of the driving telescopic member 21 is connected to the front body 40 provided with the front frame 11, and the other end of the driving telescopic member 21 is connected to the rear body 50 provided with the rear frame 12, so the spacing between the front body 40 and the rear body 50 is maximized, and the vehicle 200 is in a fully extending state, the vehicle 200 is able to be used normally. As shown in FIG. 5, when the vehicle 200 needs to be shrunk, the user presses the switch button on the vehicle 200, and the driver will drive the driving telescopic member 21, and the driving telescopic member 21 gradually shrinks along the first direction, so that the front body 40 and the rear body 50 connected to the driving telescopic member 21 gradually shrink along the first direction. As shown in FIG. 6, the spacing between the front body 40 and the rear body 50 gradually decreases, so that the length of the vehicle 200 decreases, and the vehicle 200 is in a shrinking (closed) state, which is able to reduce the occupancy space of the vehicle 200, facilitate the storage and transportation of the vehicle 200, and reduce the packaging consumable materials.

In one embodiment, the driving telescopic member 21 is a resilient member, and the resilient member can be extended or shrunk in response to being driven by the driver, thereby driving the front frame 11 to extend or shrink between the front frame 11 and the rear frame 12.

In other embodiments, as shown in FIG. 1, the driving telescopic member 21 is a driving telescopic rod. The driving telescopic member 21 includes a first tube body 211 and a second tube body 212. The first tube body 211 is slidably connected to the second tube body 212, one end of the second tube body 212 is inserted into the first tube body 211 from one end of the first tube body 211 or one end of the first tube body 211 is inserted into the second tube body 212 from one end of the second tube body 212, the other end of the first tube body 211 is connected to the front frame 11, and the other end of the second tube body 212 is connected to the rear frame 12, so that, in the case of being driven, the first tube body 211 and the second tube body 212 are slidden relative to each other along the first direction, so as to drive the front frame 11 and the rear frame 12 are slidden relative to each other along the first direction. That is, under the driving telescopic member 21 being driven by the driver, the first tube body 211 and the second tube body 212 slide relative to each other, such that the driving telescopic member 21 is extended or shrunk, to drive the front frame 11 and the rear frame 12 to extend or shrink, so as to adjust the overall length of the frame 100, and to achieve an adjustment of the length of the frame 100.

In one embodiment, the first tube body 211 of the driving telescopic member 21 is used to be connected to the driver in such a way that, in the case of being driven, the second tube body 212 does not move, and the first tube body 211 slides relative to the second tube body 212 along the first direction so as to drive the front frame 11 connected to the first tube body 211 to move toward the rear frame 12 or away from the rear frame 12 along the first direction, thereby achieving the extending or shrinking of the frame 100. For example, as shown in FIGS. 1 and 2, the first tube body 211 of the driving telescopic member 21 is used to be connected to the driver, so that, in the case of being driven, the first tube body 211 is moved along the first direction toward the rear frame 12 and the second tube body 212 does not move, so that, in the case that the rear frame 12 does not move, the front frame 11 is driven to move toward the rear frame 12, and the spacing between the front frame 11 and the rear frame 12 gradually decreases, so that the length of the frame 100 decreases, and the frame 100 is finally in a shrinking state. Also for example, as shown in FIGS. 1 and 3, the first tube body 211 of the driving telescopic member 21 is used to connect to the driver, so that, in the case of being driven, the first tube body 211 is moved away from the rear frame 12 along the first direction and the second tube body 212 does not move, such that in the case where the rear frame 12 does not move, the front frame 11 is driven away from the rear frame 12, and the spacing between the front frame 11 and the rear frame 12 is gradually increased, so that the length of the frame 100 increases and the frame 100 is restored to an extending state, and the frame 100 is able to be used normally.

In other embodiments, the second tube body 212 of the driving telescopic member 21 is used to connect to the driver, so that, in the case of being driven, the first tube body 211 is not moved, and the second tube body 212 slides relative to the first tube body 211 along the first direction, so as to drive the rear frame 12 connected with the second tube body 212 to move forward to the front frame 11 or away from the front frame 11 along the first direction, and achieve the extending or shrinking of the frame 100. For example, as shown in FIGS. 1 and 2, the second tube body 212 of the driving telescopic member 21 is used to be connected to the driver, so that, in the case of being driven, the second tube body 212 is moved along the first direction toward the front frame 11 and the first tube body 211 is not moving, so that in the case that the front frame 11 is not moving, the rear frame 12 is driven to move toward the front frame 11, and the spacing between the rear frame 12 and the front frame 11 is gradually reduced, so the length of the frame 100 is reduced, and the frame 100 is finally in a shrinking state. Further for example, as shown in FIGS. 1 and 3, the second tube body 212 of the driving telescopic member 21 is used to be connected to the driver, so that, in the case of being driven, the second tube body 212 is moved away from the rear frame 12 along the first direction and the first tube body 211 does not move, so that, in the case where the front frame 11 does not move, the rear frame 12 is driven to move away from the front frame 11, and the spacing between the rear frame 12 and the front frame 11 is gradually increased, so that the length of the frame 100 increases, the frame 100 is restored to the extending state, and the frame 100 is able to be used normally.

In other embodiments, the first tube body 211 and the second tube body 212 of the driving telescopic member 21 are simultaneously used for connecting with a driver, so that, when driven, the first tube body 211 slides along the first direction relative to the second tube body 212 and the second tube body 212 slides along the first direction relative to the first tube body 211, thereby driving the front frame 11 and the rear frame 12 to extend or shrink along the first direction, and the two tube bodies of the driving telescopic member 21 are driven at the same time to achieve the extending or shrinking of the frame 100, so as to shorter the time spent in extending or shrinking of the frame 100. For example, as shown in FIGS. 1 and 2, the first tube body 211 and the second tube body 212 of the driving telescopic member 21 are used to be connected to the driver, so that, in the case of being driven, the first tube body 211 is moved along the first direction towards the rear frame 12 and the second tube body 212 is moved along the first direction towards the front frame 11, thereby enabling the front frame 11 and the rear frame 12 to move towards each other at the same time, and the spacing between the front frame 11 and the rear frame 12 is gradually reduced, so that the length of the frame 100 is reduced, and the frame 100 is ultimately in a shrinking state. Further for example, as shown in FIGS. 1 and 3, the first tube body 211 and the second tube body 212 of the driving telescopic member 21 are used to be connected with a driver, so that, in the case of being driven, the first tube body 211 is moved away from the rear frame 12 along the first direction and the second tube body 212 is moved away from the front frame 11 along the first direction, thereby enabling the front frame 11 and the rear frame 12 to be moved away from each other at the same time, and the spacing between the front frame 11 and the rear frame 12 to gradually increase, so that the length of the frame 100 increases and the frame 100 is restored to the extending state, so that the frame 100 is able to be used normally.

In order to more stably extend or shrink the front frame 11 and the rear frame 12 along the first direction, in one embodiment, as shown in FIG. 1, the telescopic assembly 20 further includes at least one auxiliary telescopic member 22. One end of the auxiliary telescopic member 22 is connected to the front frame 11 and the other end of the auxiliary telescopic member 22 is connected to the rear frame for being driven to extend or shrink along the first direction when the driving telescopic member 21 extends or shrinks along the first direction. When the driving telescopic member 21 is driven to extend or shrink along the first direction, the auxiliary telescopic member 22 is driven to extend or shrink along the first direction, which can be regarded as that the driving telescopic member 21 and the auxiliary telescopic member 22 together drive the front frame 11 and the rear frame 12 to extend or shrink along the first direction, i.e., the driving telescopic member 21 and the auxiliary telescopic member 22 cooperate with each other to enable the frame 100 to extend or shrink.

In one embodiment, the number of auxiliary telescopic members 22 is two, i.e., the telescopic assembly 20 includes two auxiliary telescopic members 22, and the two auxiliary telescopic members 22 are provided on both sides of the driving telescopic member 21. Of course, in other embodiments, the number of auxiliary telescopic members 22 may also be one, three, four, five, etc., without any limitation. Of course, in other embodiments, the number of auxiliary telescopic members 22 is at least two, each auxiliary telescopic member 22 may be provided at the same time on one side of the driving telescopic member 21, without any limitation.

In one embodiment, the auxiliary telescopic member 22 is a resilient member, the auxiliary telescopic member 22 is an elastic member, and when the driving telescopic member 21 is extended or shrunk along the first direction, the resilient member is driven to extend or shrink along the first direction, so as to cooperate with the driving telescopic member 21 to together drive the extending or shrinking between the front frame 11 and the rear frame 12.

In other embodiments, as shown in FIG. 1, the auxiliary telescopic member 22 is the auxiliary telescopic rod. The auxiliary telescopic member 22 includes a third tube body 221 and a fourth tube body 222. The third tube body 221 is slidably connected to the fourth tube body 222, one end of the third tube body 221 is inserted into the fourth tube body 222 from one end of the fourth tube body 222 or one end of the fourth tube body 222 is inserted into the third tube body 221 from one end of the third tube body 221, the other end of the third tube body 221 is connected to the front frame 11, and the other end of the fourth tube body 222 is connected to the rear frame 12 for the third tube body 221 and the fourth tube body 222 being driven to extend or shrink along the first direction when the driving telescopic member 21 extends or shrinks along the first direction. That is that, when the driving telescopic member 21 is driven by the driver, the third tube body 221 and the fourth tube body 222 are driven and slidden relative to each other, allowing the auxiliary telescopic member 22 to extend or shrink, so as to cooperate with the driving telescopic member 21 to drive the front frame 11 and the rear frame 12 to expand or shrink, such that the overall length of the frame 100 is adjusted, and the adjustment of the length of the frame 100 is achieved.

For example, as shown in FIGS. 1 and 2, the first tube body 211 of the driving telescopic member 21 is used for connecting with the driver, so that, in the case of being driven, the first tube body 211 is moved along the first direction toward the rear frame 12 and the second tube body 212 does not move, such that the third tube body 221 is driven to move along the first direction toward the rear frame 12 and the fourth tube body 222 does not move, so that, in the case of the rear frame 12 not moving, the first tube body 211 and the third tube body 221 together drive the front frame 11 to move toward the rear frame 12, and the spacing between the front frame 11 and the rear frame 12 gradually decreases, so that the length of the frame 100 decreases, and the frame 100 is finally in a shrinking state. Also for example, as shown in FIGS. 1 and 3, the first tube body 211 of the driving telescopic member 21 is used to be connected with the driver, so that, in the case of being driven, the first tube body 211 is moved away from the rear frame 12 along the first direction and the second tube body 212 does not move, such that the third tube body 221 is driven to be moved away from the rear frame 12 along the first direction and the fourth tube body 222 does not move, so that, in the case of the rear frame 12 not moving, the first tube body 211 and the third tube body 221 together drive the front frame 11 away from the rear frame 12, the spacing between the front frame 11 and the rear frame 12 gradually increases, so that the length of the frame 100 increases, the frame 100 is restored to the extending state, and the frame 100 is capable of being used normally.

For example, as shown in FIGS. 1 and 2, the second tube body 212 of the driving telescopic member 21 is used for connecting with the driver, so that, in the case of being driven, the second tube body 212 is moved along the first direction toward the front frame 11 and the first tube body 211 does not move, so that the fourth tube body 222 is driven to move along the first direction toward the front frame 11 and the third tube body 221 does not move, so that, in the case of the front frame 11 not moving, the second tube body 212 and the fourth tube body 222 together drive the rear frame 12 to move toward the front frame 11, and the spacing between the rear frame 12 and the front frame 11 gradually decreases, so that the length of the frame 100 decreases, and the frame 100 is finally in a shrinking state. Also for example, as shown in FIGS. 1 and 3, the second tube body 212 of the driving telescopic member 21 is used for connecting with a driver, so that, in the case of being driven, the second tube body 212 is moved away from the front frame 11 along the first direction and the first tube body 211 does not move, so that the fourth tube body 222 is driven away from the front frame 11 along the first direction and the third tube body 221 does not move, so that, in the case where the front frame 11 does not move, the rear frame 12 is driven away from the front frame 11, and the spacing between the rear frame 12 and the front frame 11 is gradually increased, so that the length of the frame 100 increases, and the frame 100 is restored to an extending state, so that the frame 100 is able to be used normally.

For example, as shown in FIGS. 1 and 2, the first tube body 211 and the second tube body 212 of the driving telescopic member 21 are used to be connected with the driver, so that, in the case of being driven, the first tube body 211 is moved toward the rear frame 12 along the first direction and the second tube body 212 is moved toward the front frame 11 along the first direction, so that the third tube body 221 is driven to move toward the rear frame 12 along the first direction, and the fourth tube body 222 is driven to move toward the front frame 11 along the first direction, so that the front frame 11 and the rear frame 12 are simultaneously driven toward each other under the operative driving of the first tube body 211, the second tube body 212, the third tube body 221, and the fourth tube body 222, the spacing between the front frame 11 and the rear frame 12 gradually decreases, such that the length of the frame 100 decreases and the frame 100 is eventually in a shrinking state. Also for example, as shown in FIGS. 1 and 3, the first tube body 211 and the second tube body 212 of the driving telescopic member 21 are used to connect with the driver, so that, in the case of being driven, the first tube body 211 is moved away from the rear frame 12 along the first direction and the second tube body 212 is moved away from the front frame 11 along the first direction, so that the third tube body 221 is driven to move away from the rear frame 12 along the first direction, and the fourth tube body 222 is driven to move away from the front frame 11 along the first direction, such that the front frame 11 and the rear frame 12 to move away from each other at the same time under the cooperative driving of the first tube body 211, the second tube body 212, the third tube body 221, and the fourth tube body 222, and the spacing between the front frame 11 and the rear frame 12 gradually increases, so that the length of the frame 100 increases, and the frame 100 is restored to the extending state, so that the frame 100 is capable of being used normally.

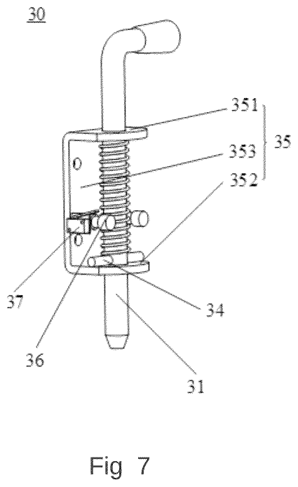

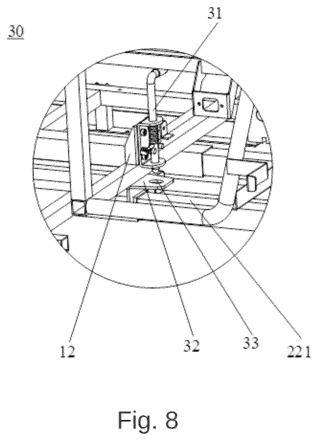

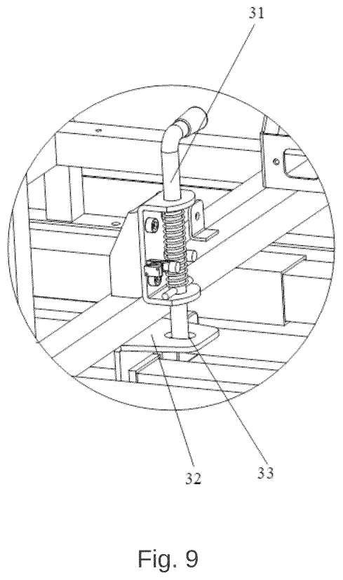

With reference to FIGS. 7-9, FIG. 7 is a schematic structural diagram of an embodiment of a restraining assembly provided in the present application; FIG. 8 is a schematic partial structure diagram of an embodiment of a frame provided in the present application; FIG. 9 is a schematic partial structure diagram the of another embodiment of the frame provided in the present application. In one embodiment, the frame 100 further includes a restraining assembly 30 comprising a restraining pin 31 and a restraining plate 32. The restraining pin 31 is movably connected to the rear frame 12, the restraining plate 32 is provided at one end of the third tube body 221 near the restraining pin 31 or provided at one end of the fourth tube body 222 near the restraining pin 31, and the restraining plate 32 is provided with a restraining hole 33 for the restraining pin 31 to penetrate. In the case where the restraining pin 31 provided on the rear frame 12 is penetrated through the restraining hole 33 provided on the third tube body 221, i.e., in the case where the restraining pin 31 is inserted in the restraining hole 33, the third tube body 221 is unable to execute a relative movement between the third tube body 221 and the rear frame 12, so that the front frame 11 connected to the third tube body 221 and the driving telescopic member 21 are unable to execute a relative movement with the rear frame 12, and thus, even in the case where the driving telescopic member 21 is driven, the driving telescopic member 21 cannot extend or shrink along the first direction, so that the front frame 11 and the rear frame 12 cannot be driven to extend or shrink along the first direction; i.e., the frame 100 can be restricted from extending or shrinking when the restraining pin 31 is inserted in the restraining hole 33. Therefore, by providing the restraining assembly 30, it is possible to restrict the telescopic movement of the frame 100, thereby avoiding the telescopic movement of the frame 100 in the process of use, storage, and transportation due to mistaken touch.

It should be noted that if the frame 100 needs to be shrunk, it needs to be operated to pull the restraining pin 31 to be released from the restraining plate 32, and then to drive the driving telescopic member 21, so as to be able to carry out the work of shortening or lengthening of the frame 100.

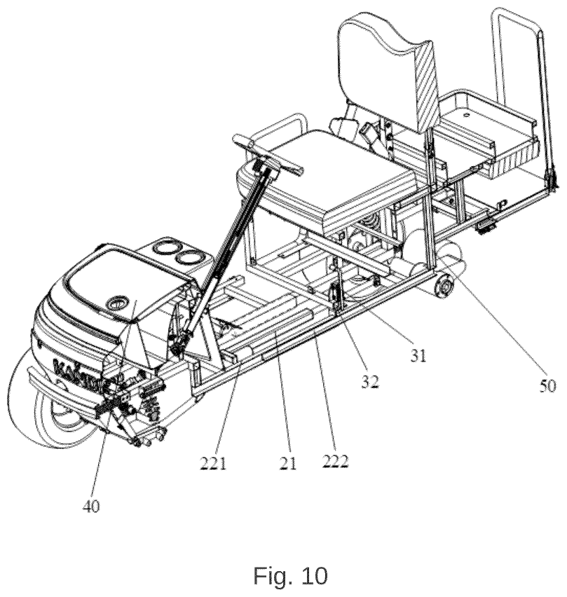

For example, as shown in FIG. 10, FIG. 10 is a cross-sectional view of an embodiment of a vehicle provided in the present application. By controlling the switch button on the vehicle 200, it is possible to give the driver control information, and the driver drives the driving telescopic member 21 to extend or contract, so as to drive the front body 40 provided with the front frame 11 and the rear body 50 provided with the rear frame 12 to extend or shrink along the first direction. When the restraining pin 31 is inserted in the restraining hole 33, the third tube body 221 is unable to become relatively movable with the third tube body 221, so that the front body 40 connected to the third tube body 221 as well as the driving telescopic member 21 are unable to become relatively movable with the rear body 50, and therefore, even in the case where the driving telescopic member 21 is driven, the driving telescopic member 21 is unable to extend or shrink along the first direction, and therefore the front body 40 and the rear body 50 are unable to drive to extend or shrink along the first direction; i.e., when the restraining pin 31 is inserted in the restraining hole 33, it is capable of restricting the telescopic movement of the body of the vehicle 200. Therefore, by providing the restraining assembly 30, it is possible to restrict the telescopic movement of the vehicle 200, thereby avoiding the telescopic movement of the vehicle 200 during use, storage, and transportation due to an accidental touch of the switch.

In one embodiment, as shown in FIG. 7, the restraining pin 31 is convexly provided with a first restraining post 34. The restraining assembly 30 further includes a restraining bracket 35 comprising a first connecting plate 351 and a second connecting plate 352 provided in opposite and spaced apart positions, and a third connecting plate 353 connecting one end of the first connecting plate 351 to one end of the second connecting plate 352. The third connecting plate 353 is connected to the rear frame 12, the restraining pin 31 is passed through the first connecting plate 351 and the second connecting plate 352 in sequence and is movably connected to the restraining bracket 35. One side of the third connecting plate 353 facing the restraining pin 31 is convexly provided with two spaced apart second restraining posts 36. When the restraining pin 31 is released from the restraining plate 32, the restraining pin 31 is suspended from the two second restraining posts 36 by the first restraining post 34. In particular, when the restraining pin 31 is in a released state with the restraining plate 32, the restraining pin 31 is suspended from the two second restraining posts 36 by the first restraining post 34, and the two restraining posts cooperate with the first restraining post 34 to avoid that the restraining pin 31 slides downwardly and inserts in the restraining holes 33 of the restraining plate 32, so as to avoid that the telescopic change of the frame 100 is affected due to the sliding of the restraining pin 31. When the restraining pin 31 is in an inserted state with the restraining plate 32, the first restraining post 34 of the restraining pin 31 abuts against the second connecting plate 352 to avoid the restraining pin 31 from releasing from the restraining bracket 35.

In one embodiment, the outer peripheral edge of the second restraining post 36 is provided with a groove, and the first restraining post 34 is snapped into the groove when the first restraining pin 31 is suspended from both the second restraining posts 36 by means of the first restraining post 34. That is, when the first restraining post 34 is snapped in the groove of the second restraining post 36, it is possible to avoid that the first restraining post 34 slides relative to the second restraining post 36 and detaches the second restraining post 36 when the first restraining post 34 is suspended from the second restraining post 36, thereby avoiding that the restraining pin 31 is detached from the second restraining post 36 when the first restraining post 34 is suspended from the second restraining post 36. In particular, as shown in FIG. 8, when the restraining pin 31 is in a detached state from the restraining plate 32, the restraining pin 31 is suspended from the two second restraining posts 36 by the first restraining post 34, and the two restraining posts cooperate with the first restraining post 34 to avoid that the restraining pin 31 slides downwardly and inserts in the restraining holes 33 of the restraining plate 32, so as to avoid that the telescopic change of the frame 100 is affected due to the sliding of the restraining pin 31. As shown in FIG. 9, when the restraining pin 31 is in an inserted state with the restraining plate 32, the first restraining post 34 of the restraining pin 31 abuts against the second connecting plate 352 to avoid the restraining pin 31 from detaching from the restraining bracket 35.

In one embodiment, the restraining pin 31 convexly is provided with a first restraining post 34, and the restraining assembly 30 further comprises a restraining bracket 35 and a tactile switch 37. The restraining bracket 35 is provided on the rear frame 12, and the restraining pin 31 is movably provided on the restraining bracket 35. The tactile switch 37 is mounted on the restraining bracket 35 and used for electrical connection to the driver. Upon the restraining pin 31 is detached from the restraining plate 32, the first restraining post 34 is crimped to the tactile switch 37; upon the restraining pin 31 is inserted into the restraining hole 33, the first restraining post 34 is detached from the tactile switch 37. When the restraining pin 31 is detached from the restraining plate 32, the first restraining post 34 is crimped on the tactile switch 37, which, on the one hand, enables the tactile switch 37 to be turned on and the tactile switch 37 sends a signal to the driver to restrict the normal use of the frame 100, so as to avoid the use of the frame 100 in case the restraining pin 31 is not in the state of being inserted with the restraining plate 32; on the other hand, the tactile switch 37 is able to receive the first restraining post 34 to avoid the restraining pin 31 from sliding downwardly and inserting in the restraining hole 33 of the restraining plate 32, so as to avoid that the telescopic change of the frame 100 is affected due to the sliding of the restraining pin 31.

For example, in the specific application of the frame 100 to the vehicle 200, in case that the restraining pin 31 is detached from the restraining plate 32, the first restraining post 34 is crimped to the tactile switch 37, which will enable the tactile switch 37 to be turned on, and the tactile switch 37 sends a signal to the driver to restrict the driver from starting or driving the vehicle when the restraining pin 31 is not in the state of being inserted in the restraining hole 33 on the restraining plate 32.

In one embodiment, the restraining bracket 35 comprises a first connecting plate 351 and a second connecting plate 352 provided in opposite and spaced apart positions, and a third connecting plate 353 connecting one end of the first connecting plate 351 to one end of the second connecting plate 352. The third connecting plate 353 is connected to the rear frame 12, the restraining pin 31 is passed through the first connecting plate 351 and the second connecting plate 352 in sequence and movably connected to the restraining bracket 35. One side of the third connecting plate 353 facing the restraining pin 31 is convexly provided with two spaced apart second restraining posts 36, and the tactile switch 37 is provided adjacent to one of the second restraining posts 36. After the restraining pin 31 is detached from the restraining plate 32, the restraining pin 31 is suspended from both the second restraining posts 36 by means of the first restraining post 34 and is crimped to the tactile switch 37. When the restraining pin 31 is detached from the restraining plate 32, the restraining pin 31 is suspended from the two second restraining posts 36 by the first restraining post 34 and is crimped to the tactile switch 37, which, on the one hand, enables the tactile switch 37 to be turned on and the tactile switch 37 to send a signal to the driver to restrict the normal use of the frame 100 so as to avoid the normal use of the frame 100 in the case in which the restraining pin 31 is not in the state of being inserted to the restraining plate 32; on the other hand, the two second restraining posts 36 cooperate with the first restraining post 34 to avoid the restraining pin 31 from sliding downwardly and inserting in the restraining hole 33 of the restraining plate 32, so as to avoid that the telescopic change of the frame 100 is affected due to the sliding of the restraining pin 31.

Distinguished from prior art, a frame for vehicle is provided; the frame includes a frame assembly and a telescopic assembly; a frame assembly includes a front frame and a rear frame; a telescopic assembly includes a driving telescopic member for connecting to a driver, one end of the driving telescopic member connected to the front frame and the other end connected to the rear frame for extending or shrinking in the first direction under the drive of the driver, so as to drive the front frame and the rear frame to extend or shrink along the first direction. When the driving telescopic member is extended or shrunk along the first direction, it can drive the front frame and the rear frame connected thereto to extend or shrink along the first direction, so as to adjust the overall length of the frame, and achieve the adjustment of the length of the frame; on the other hand, the driving telescopic member is extended or shrunk along the first direction under the situation of being driven by a driver, i.e., the driving telescopic member, when driven by a driver, is able to automatically drive the front frame and the rear frame to extend or shrink along the first direction, and the adjustment of the extending or shrinking of the frame is more flexible and convenient. Therefore, by providing the driving telescopic member connected to the driver between the front frame and the rear frame, adjustment of the length of the frame is achieved, and the length of the frame can be adjusted more flexibly and conveniently.

Referring further to FIG. 4, the present application also provides a vehicle that includes the frame assembly described above. When the driving telescopic member is extended or shrunk along the first direction, it can drive the front frame and the rear frame connected thereto to extend or shrink along the first direction, so as to adjust the overall length of the frame, and achieve the adjustment of the length of the frame; on the other hand, the driving telescopic member is extended or shrunk along the first direction under the situation of being driven by a driver, i.e., the driving telescopic member, when driven by a driver, is able to automatically drive the front frame and the rear frame to extend or shrink along the first direction, and the adjustment of the extending or shrinking of the frame is more flexible and convenient. Therefore, by providing the driving telescopic member connected to the driver between the front frame and the rear frame, adjustment of the length of the frame is achieved, and the length of the frame can be adjusted more flexibly and conveniently. Therefore, the length of the bodywork of the vehicle provided in the present application can also be adjusted more flexibly and conveniently.

Optionally, the vehicle may be a golf cart, a sightseeing cart, a mobility scooter, etc., without limitation herein.

The above is only an embodiment of the present application and is not intended to limit the scope of the patent of the present application. Any equivalent structure or equivalent process changes utilizing the contents of the specification of the present application and the accompanying drawings, or directly or indirectly utilized in other related technical fields, are all reasonably included in the scope of protection of the patent of the present application. While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. A vehicle frame comprising:
a frame assembly including a front frame and a rear frame;
a telescopic assembly including a driving telescopic member for connecting to a driver, one end of the driving telescopic member is coupled to the front frame and the other end is coupled to the rear frame;
wherein the driving telescopic member extends or shrinks in a first direction under the drive of the driver to cause the front frame and the rear frame to extend or shrink along the first direction.

2. The vehicle frame according to claim 1, wherein the driving telescopic member includes a first tube body and a second tube body;
the first tube body is slidably coupled to the second tube body;
one end of the second tube body is inserted into the first tube body or one end of the first tube body is inserted into the second tube body;
an opposite end of the first tube body is coupled to the front frame, and an opposite end of the second tube body is coupled to the rear frame;
the first tube body and the second tube body being slidden relative to each other along the first direction based on the case of being driven, so as to drive the front frame and the rear frame to slide relative to each other along the first direction.

3. The vehicle frame according to claim 1, wherein the telescopic assembly further includes at least one auxiliary telescopic member;
one end of the auxiliary telescopic member is coupled to the front frame and an opposite end of the auxiliary telescopic member is coupled to the rear frame to extend or shrink along the first direction when the driving telescopic member extends or shrinks along the first direction.

4. The vehicle frame according to claim 1, wherein the auxiliary telescopic member includes a third tube body and a fourth tube body;
the third tube body is slidably coupled to the fourth tube body, wherein one end of the third tube body is inserted into the fourth tube body or one end of the fourth tube body is inserted into the third tube body,
an opposite end of the third tube body is coupled to the front frame, and an opposite end of the fourth tube body is connected to the rear frame;
the third tube body and the fourth tube body extending or shrinking along the first direction when the driving telescopic member extends or shrinks along the first direction; and/or
the telescopic assembly includes two auxiliary telescopic members, each located on either side of the driving telescopic member.

5. The vehicle frame according to claim 4, wherein the frame further includes:
a restraining assembly, including a restraining pin and a restraining plate;
the restraining pin movably coupled to the rear frame;
the restraining plate located at one end of the third tube body within connective proximity to the restraining pin,
the restraining plate comprising a restraining hole where the restraining pin can be movably inserted; and
the restraining plate capable of restricting the driving telescopic member from extending or shrinking along the first direction based on the restraining pin being inserted into the restraining hole on the restraining plate, so as to restrain the front frame and the rear frame from extending or shrinking along the first direction.

6. The vehicle frame according to claim 5, wherein the restraining assembly further includes:
a restraining bracket comprising a first connecting plate and a second connecting plate located in opposite each other and spaced apart;
a third connecting plate coupling one end of the first connecting plate to one end of the second connecting plate, and coupled to the rear frame;
the restraining pin inserted through the first connecting plate and the second connecting plate in sequence, and movably coupled to the restraining bracket;
the restraining pin located between a first restraining post, one side of the third connecting plate, and convexly located between two spaced apart second restraining posts; and
wherein the restraining pin is suspended from the first and second restraining post, and the driving telescopic member is capable of extending or shrinking along the first direction based on the restraining pin being detached from the restraining plate, so as to drive the front frame and the rear frame to be capable of extending or shrinking along the first direction.

7. The vehicle frame according to claim 6, wherein an outer peripheral edge of the second restraining post contains a groove, and the first restraining post is snapped into the groove when the first restraining pin is suspended from the first and second restraining post.

8. The vehicle frame according to claim 5, wherein the restraining pin is convexly located relative to a first restraining post, and the restraining assembly further comprises:
a restraining bracket, located on the rear frame, and the restraining pin movably located on the restraining bracket;
a tactile switch, mounted on the restraining bracket and used for an electrical connection to the driver;
the first restraining post is crimped to the tactile switch, and the driving telescopic member is capable of extending or shrinking along the first direction based on the restraining pin being detached from the restraining plate, so as to drive the front frame and the rear frame to be capable of extending or shrinking along the first direction; and
wherein the first restraining post is detached from the tactile switch based on the restraining pin being inserted into the restraining hole on the restraining plate.

9. The vehicle frame according to claim 8, wherein the restraining bracket comprises:
a first connecting plate and a second connecting plate located opposite to each other and spaced apart;
a third connecting plate connecting one end of the first connecting plate to one end of the second connecting plate, and coupled to the rear frame;
the restraining pin inserted through the first connecting plate and the second connecting plate in sequence, and movably connected to the restraining bracket;
one side of the third connecting plate facing the restraining pin is convexly located between two spaced apart second restraining posts;
the tactile switch located adjacent to one of the second restraining posts; and
wherein the restraining pin is suspended from both the second restraining posts by means of the first restraining post and is crimped to the tactile switch based on the restraining pin being detached from the restraining plate.

10. A vehicle comprising the vehicle frame according to claim 1.
